(19) United States
(12) Patent Application Publication
(10) Pub. No.: US 2002/0087763 A1
(43) Pub. Date: Jul. 4, 2002

(54) Communication sytem with a communication bus

(76) Inventor: Wilhard Von Wendorff, Munchen (DE)

Correspondence Address: LERNER AND GREENBERG P.A., Post Office Box 2480, Hollywood, FL, 33022-2480, US

(21) Appl. No.: 10/021,705

(22) Filed: Nov. 13, 2001

Related U.S. Application Data
(63) Continuation of application No. PCT/DE00/01498, filed on May 12, 2000.

(30) Foreign Application Priority Data
May 12, 1999 (DE) 199 22 171.5

(51) Int. Cl. G06F 13/00

(52) U.S. Cl. 710/100

(57) ABSTRACT

A communication system having several transmitter and receiver units and a ring-shaped communication bus for transmitting communication information between the individual transmitter and receiver units so that each transmitter and receiver unit is connected clockwise and counterclockwise to a neighboring transmitter and receiver unit by the communication bus. The ring-shaped bus structure enhances transmission safety of the communication system.

### CROSS-REFERENCE TO RELATED APPLICATION

This application is a continuation of copending International Application No. PCT/DE00/01498, filed May 12, 2000, which designated the United States.

### BACKGROUND OF THE INVENTION

### FIELD OF THE INVENTION

The present invention relates to a communication system having plurality of transceivers and a communication bus that enables communication between the transceivers.

Such communication systems are needed for different types of applications and are used, for example, particularly in vehicles for driving various loads. These loads, in turn, can be combined in subsystems which communicate with one another via the communication bus.

Due to the increasing complexity of such communication systems, the reliability and error protection of these communication systems is becoming increasingly more important. This particularly applies to critical safety-related communication systems with respect to their tolerance to individual faults or multiple faults (e.g. wire breaks, etc.) which may occur in the communication system.

The international TTP/C (Time Triggered Protocol Class C) standard is currently being discussed as a possible approach to reduce the probability of faulty communication. The configuration of a communication system according to the TTP/C standard is shown diagrammatically in FIG. 5, which shows a number of transceivers 2 connected to a communication bus 1. The communication bus 1 is used for transmitting communication information or messages between the individual transceivers 2. The communication system automatically decides by means of a predetermined time schedule which transceiver 2 is allowed to transmit messages at what time. For this purpose, each transceiver 2 includes its own protocol processor 3 which accesses a memory 4 in which unit-specific control data (message descriptor list, MEDL) are stored. These TTP/C control data define the time at which the processor 3 of the corresponding transceiver 2 can transmit a message via the communication bus 1. The processor 3 communicates, via a communication network interface 5 (CNI), with a corresponding host computer 6 which is connected to a number of objects or loads to be controlled (and not shown in FIG. 5 for the sake of clarity) via an I/O interface 7. Each transceiver 2 is thus associated with one subsystem of the total system.

As shown in FIG. 5, according to the TTP/C standard, a communication bus 1 is proposed which includes two redundant communication channels or communication lines in order to reduce the probability of faulty communication. Messages to be transmitted are transmitted synchronously, i.e. simultaneously, via both communication channels. However, it is only possible to reduce the probability of the occurrence of individual point errors by means of this approach. The essential problem associated with bus structures, namely the complete failure of the communication system if all of the bus lines are interrupted at one point, cannot be eliminated by this approach. Furthermore, such a complete interruption of the communication bus 1 would divide the communication bus 1 into two independent part-bus systems which are not connected to one another. For this reason, when the TTP/C standard is applied, it is necessary to use two different routing channels for guiding the two bus lines, which channels are arranged in such a manner that the bus lines do not run in parallel at any point. At each node of the communication system, i.e. at each transceiver 2, however, it is necessary to run the two bus lines in parallel into the transceiver 2. Furthermore, there is the problem that in applications in vehicles, nodes arranged, for example, in doors or wheels, can generally only be accessed via one routing channel.

The TTP/C approach does not, therefore, provide a completely error-tolerant communication bus structure.

### SUMMARY OF THE INVENTION

It is accordingly an object of the invention to provide a communication system which overcomes the above-mentioned disadvantageous of the prior art methods of this general type. In particular, it is an object of the invention to provide a communication bus that has improved reliability.

With the foregoing and other objects in view there is provided, in accordance with the invention a communication system, that includes a plurality of transceivers, and a communication bus connected to the plurality of the transceivers to enable transmission of communication information between individual ones of the plurality of the transceivers. The communication bus has a ring-shaped structure connecting each one of the plurality of the transceivers to a respective one of the plurality of the transceivers that is adjacent in a clockwise direction, which is defined as a respective clockwise adjacent transceiver, and to a respective one of the plurality of the transceivers that is adjacent in a counterclockwise direction, which is defined as a respective counterclockwise adjacent transceiver. The communication bus has a plurality of bus sections defining a plurality of first bus sections and a plurality of second bus sections. Each one of the plurality of the transceivers is connected to the respective clockwise adjacent transceiver via a respective one of plurality of the first bus sections. Each one of the plurality of the transceivers is connected to the respective counterclockwise adjacent transceiver via a respective one of the plurality of the second bus sections. Each one of the plurality of the transceivers includes a first receiver and a first transmitter that are associated with a respective one of the plurality of the first bus sections. Each one of the plurality of the transceivers includes a second receiver and a second transmitter that are associated with a respective one of the plurality of the second bus sections. Each one of the plurality of the transceivers includes a control device for controlling the first receiver, the second receiver, the first transmitter, and the second transmitter.

In accordance with an added feature of the invention, the control device is constructed to activate the first transmitter for transmitting first ones of the communication information in the clockwise direction via the communication bus, and the control device is constructed to activate the second transmitter for transmitting second ones of the communication information in the counterclockwise direction via the communication bus.

In accordance with an additional feature of the invention, the control device of each one of the plurality of the transceivers is constructed such that, when the first ones of the communication information and the second ones of the communication information are not being transmitted by a particular one of the plurality of the transceivers, the control device of the particular one of the plurality of the transceivers activates the corresponding first receiver and the second receiver.

In accordance with another feature of the invention, the control device of each one of the plurality of the transceivers is constructed such that, when ones of the communication information not intended for the one of the plurality of the transceivers is received by the first receiver or the second receiver of the one of the plurality of the transceivers, the control device of the one of the plurality of the transceivers activates either the first transmitter or the second transmitter of the one of the plurality of the transceivers.

In accordance with a further feature of the invention, the control device of each one of the plurality of the transceivers is constructed such that, when a communication information not intended for the one of the plurality of the transceivers is received by either the first receiver or the second receiver of the one of the plurality of the transceivers, then the control device activates either the first transmitter or the second transmitter, only if no communication information is currently being received via one of the plurality of the bus sections associated the transmitter to be activated.

In accordance with a further added feature of the invention, 5 each one of the plurality of the transceivers includes a storage device for storing stored communication information that is selected from the group consisting of information to be transmitted and information to be forwarded.

In accordance with a further additional feature of the invention, the control device is constructed such that, if ones of the communication information are currently being received via the respective one of the plurality of the first bus sections and if the first transmitter is to be activated, then after a predetermined delay time, the stored communication information is read out from the storage device and is attempted to be forwarded via the respective one of the plurality of the first bus sections. The control device is also constructed such that, if ones of the communication information are currently being received via the respective one of the plurality of the second bus sections and if the second transmitter is to be activated, then after a predetermined delay time, the stored communication information is read out from the storage device and is attempted to be forwarded via the respective one of the plurality of the second bus sections.

In accordance with another further feature of the invention, the control device is constructed such that, when an operation is being performed that is selected from the group consisting of transmitting the communication information and forwarding the communication information, the control device checks for an error and if the error is found, the control device, after a given delay time, causes an operation to be performed that is selected from the group consisting of retransmitting the communication information and forwarding the communication information via a transmitter that is selected from the group consisting of the first transmitter and the second transmitter.

In accordance with yet an added feature of the invention, the control device of each one of the plurality of the transceivers is constructed to identify retransmitted communication information; and the control device of each one of the plurality of the transceivers is constructed such that:

when ones of the communication information, which are not intended for the one of the plurality of the transceivers and which have been identified as being retransmitted by the control device of another one of the plurality of the transceivers, are received during forwarding of the ones of the communication information because of an error, the control device of the one of the plurality of the transceivers prevents a retransmission of the ones of the communication information, and

when the ones of the communication information, which are not intended for the one of the plurality of the transceivers and which have been identified as being retransmitted by the control device of another one of the plurality of the transceivers, are received when a bus section, selected from the group consisting of an occupied one of the plurality of the first bus sections and an occupied one of the plurality of the second bus sections, via which the ones of the communication information are to be forwarded, the control device of the one of the plurality of the transceivers prevents a retransmission of the ones of the communication information.

In accordance with yet an additional feature of the invention, each one of the plurality of the transceivers includes a storage device for storing communication information that is defined as stored communication information and that is selected from the group consisting of information to be transmitted and information to be forwarded. For each one of the communication information to be transmitted, a particular one of the plurality of the transceivers is defined as switching unit. The control device of the switching unit is constructed such that, when corresponding ones of the communication information are received via a corresponding bus section selected from the group consisting of one of the plurality of the first bus sections and one of the plurality of the second bus sections, the control device of the switching unit temporarily stores the ones of the communication information in the storage means of the switching unit and forwards the ones of the communication information via another corresponding bus section selected from the group consisting of one of the plurality of the first bus sections and one of the plurality of the second bus sections, after a predetermined period of time has elapsed.

In accordance with yet another feature of the invention, the control device of the switching unit is constructed such that, if within the predetermined period of time, the corresponding ones of the communication information have been received both via one of the plurality of the first bus sections and one of the plurality of the second bus sections, the control device of the switching unit temporarily stores the corresponding ones of the communication information and after the predetermined period of time has elapsed, the control device of the switching unit forwards the corresponding ones of the communication information.

In accordance with yet a further feature of the invention, the control device of the switching unit is constructed such that, if within the predetermined period of time, the corresponding ones of the communication information have been received only via a bus section selected from the group consisting of one of the plurality of the first bus sections and one of the plurality of the second bus sections, the control device of the switching unit only reads out of the storage means and forwards the corresponding ones of the communication information.

In accordance with another added feature of the invention, the communication bus includes a first communication channel for exclusively transmitting the communication information in the clockwise direction; and the communication bus includes a second communication channel for exclusively transmitting the communication information in the counterclockwise direction.

In accordance with another additional feature of the invention, the control device is constructed to activate the first transmitter to transmit the first ones of the communication information in the clockwise direction via the first communication channel; and the control device is constructed to activate the second transmitter to transmit the second ones of the communication information in the counterclockwise direction via the second communication channel.

In accordance with an important feature of the invention, the communication bus is provided with a ring-shaped structure for transmitting communication information between transceivers connected to the communication bus. Each transceiver is thus connected to an adjacent transceiver both in the clockwise direction and in the counterclockwise direction via the communication bus.

The aforementioned bus structure has the advantage that, even when the communication bus is interrupted, each transceiver can still receive communication information from every other transceiver via the half of the ring not affected by the interruption. A further advantage of the present invention consists in that the individual communication lines of the communication bus can be terminated locally-correctly and independently of the total number of transceivers-at every node and at every transceiver, respectively, since preferably only point-to-point connections exist.

Communication information or messages can be transmitted via the ring-shaped communication bus in accordance with different implementations. Thus, for example, the communication bus can be provided with a single ring structure via which the same messages or also two different messages can be transmitted bidirectionally. Furthermore, the communication bus can be provided with a dual ring structure in which messages can be transmitted in opposite directions via the individual bus rings.

Other features which are considered as characteristic for the invention are set forth in the appended claims.

Although the invention is illustrated and described herein as embodied in a communication system with a communication bus, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 shows the basic configuration of a communication system;

FIG. 2 illustrates the correct termination of communication lines in the communication system shown in FIG. 1;

FIG. 3 shows first and second exemplary embodiments of the invention;

FIG. 4 shows a third exemplary embodiment of the invention; and

FIG. 5 shows a prior art communication system.

### DESCRIPTION OF THE PREFERRED EMBODIMENTS

Referring now to the figures of the drawing in detail and first particularly to FIG. 1 thereof, there is shown the basic configuration of an inventive communication system. As can be seen in FIG. 1, the communication system includes a number of transceivers 2 which are connected to a ring-shaped communication bus 1. The communication bus 1 includes bus sections which preferably in each case connect two adjacent transceivers 2 to one another via point-to-point connections. If, for example, all lines of the communication bus 1 are interrupted or short-circuited at the point A or B shown in FIG. 1, there is still one ring half of the communication bus 1 which makes it possible for each transceiver 2 to communicate with every other transceiver. Thus, for example, when an interruption occurs at point C, the transceiver No. 1 can still communicate with the transceiver No. 2 via transceivers No. 4 and No. 3. Even when the worst possible fault occurs at point B, only communication with a single node or a single transceiver 2, i.e. transceiver No. 2, would be interrupted.

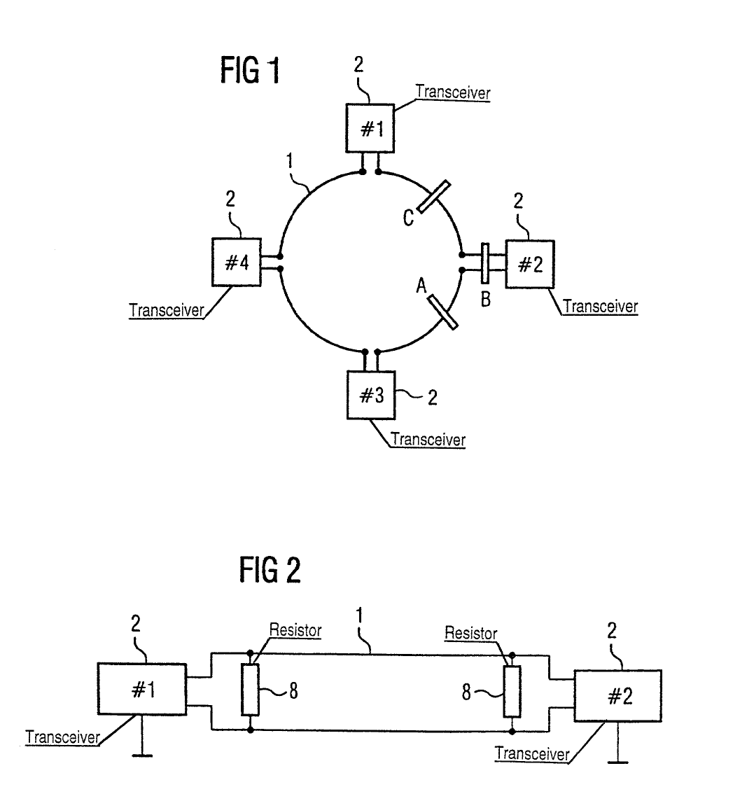

Each of the bus sections of the communication bus 1 shown in FIG. 1 can be correctly terminated locally. The reason for this is the fact, outlined in FIG. 2, that each of these bus sections is formed by a point-to-point connection between two adjacent transceivers, between transceivers No. 1 and No. 2 in the example shown in FIG. 2. Each of the bus lines of this bus section can thus be correctly terminated by a suitable choice of the respective terminating resistor 8 at the corresponding transceiver. By changing the bit representation, communication bus faults such as, for example, a simple short circuit or cable break can be detected and then eliminated in a simple manner using the ring-shaped bus structure shown in FIG. 1.

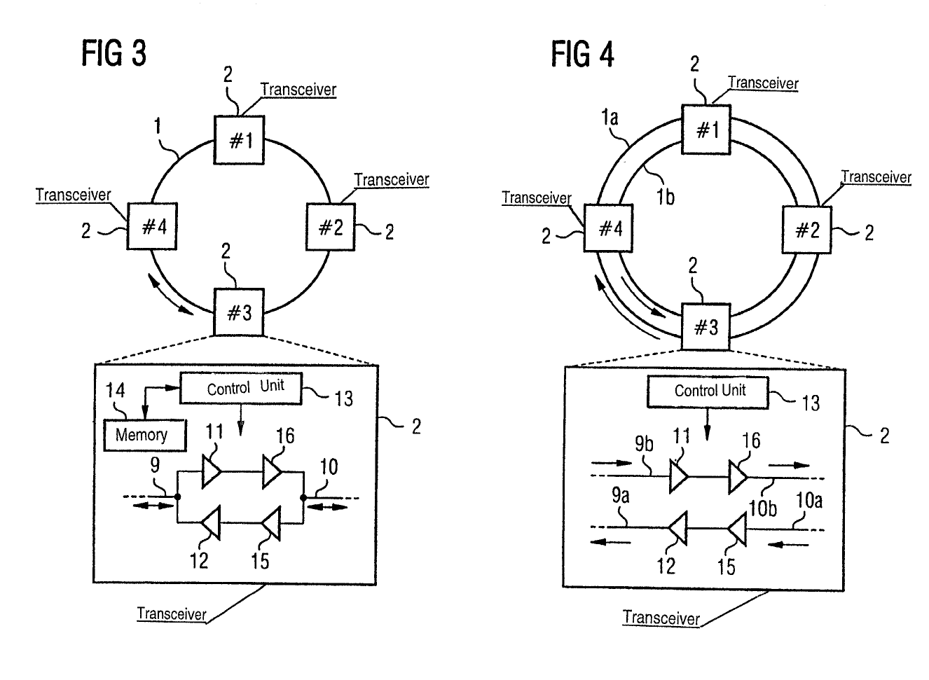

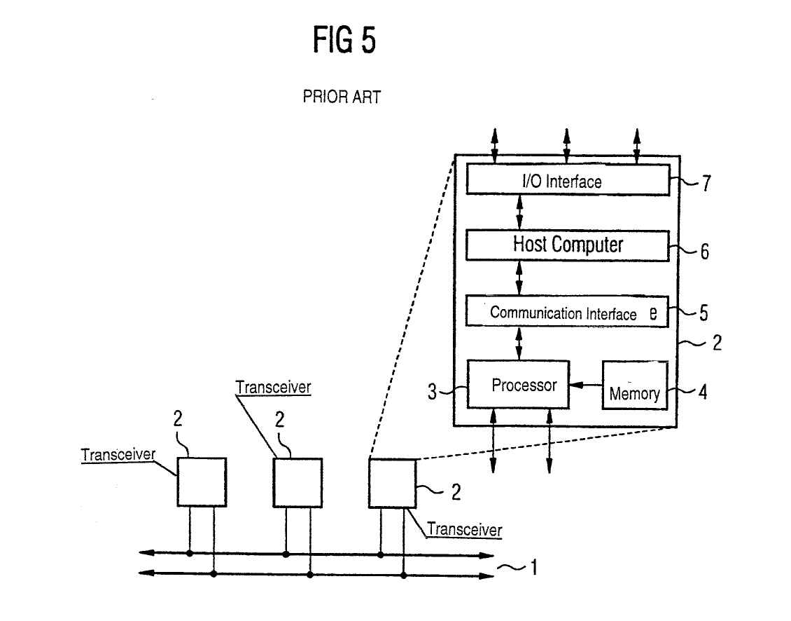

FIG. 3 shows a first and a second embodiment of an illustrative embodiment of a communication system.

The first illustrative embodiment enables bidirectional communication via a bus ring 1, in which a transceiver 2 transmits messages or communication information redundantly in both directions, i.e. both in the clockwise direction and in the counterclockwise direction.

As shown in FIG. 3, each transceiver 2 includes receivers 11 and 15. Receiver 11 is provided for the left-hand bus section 9 of the communication bus 1 and receiver 15 is provided for the right-hand bus section 10. Similarly, there are separate transmitters 12 and 16 for transmitting messages via bus section 9 and 10. The operation of the transmitters and the receivers is controlled by a control unit 13.

Each transceiver transmits a message to be transmitted redundantly in both directions, i.e. both via bus section 9 and via bus section 10, in that the corresponding transmitters 12 and 16 are activated by the control unit 13. All transceivers which do not transmit activate the receivers 11 and 15 for their two bus sections 9 and 10 and forward messages which are not intended for them in the direction of transmission by activating the corresponding transmitters 12 and 16. A timing sequence control ensures that each transceiver only transmits a message once.

According to the first illustrative embodiment, different messages are not transmitted via the different transmission directions or transmission channels, but rather it is ensured that only the same message is always transmitted bidirectionally in both directions since otherwise the bus ring would be subdivided into two subsystems, and in the case of a faulty transmission of one of the two messages, an average of 50% of the transceivers 2 would receive a message which is wrong or cannot be read.

According to the second illustrative embodiment, however, bidirectional transmission of different messages via the ring-shaped communication bus 1 should be possible and the configuration, already explained, of the transceivers 2 is supplemented for this purpose by a memory 14 shown in FIG. 3. In this memory 14, the control unit 13 temporarily stores each message to be transmitted or to be forwarded by the corresponding transceiver 2.

According to the second illustrative embodiment, each transceiver 2 can transmit different messages in different directions so that one message is transmitted in the clockwise direction and the other message is transmitted in the counterclockwise direction. The transceiver No. 3 thus transmits a message to the transceiver No. 1, for example in the clockwise direction, whereas, at the same time, another message is transmitted to transceiver No. 2 in the counterclockwise direction. Two different approaches are conceivable for forwarding these messages.

In both approaches, receivers 11 and 15 are again activated for both directions of transmission or, respectively, bus sections 9 and 10 in all transceivers 2 which are not transmitting. A received message is forwarded in the direction of transmission by activating the corresponding transmitter 12 or 16, respectively, unless it comes from the respective transmitting unit itself.

According to the first approach, however, a check is first made in this case on whether the bus section 9 or 10 via which the message is to be forwarded is already currently receiving a message or not. If it is, the message temporarily stored in memory 14 is read out after a certain period of time and another attempt at forwarding the message is made. Similarly, during the transmission of a message, the control unit 13 is used for checking whether this message is correct. If an error is found during this process, the message stored in memory 14 is read out, after a certain period of time has elapsed, and is retransmitted. Each retransmitted message is identified as being a retransmitted message by a corresponding bit so that any other transceiver can see if the message received is a message which has already been transmitted twice by another transceiver 2. This prevents another transceiver 2 from being able to transmit this message again.

The aforementioned delay times are identical for all transmitters 12 and 16, respectively, but the delay times can be different for the two directions of transmission.

According to the second approach, a switching node or a switching transceiver 2 is designated for each message to be transmitted. This switching node or switching transceiver temporarily stores, in its memory 14, both messages of the transmitting transceiver that are transmitted in different directions. After the received messages have been temporarily stored, the messages are forwarded after a certain period of time has elapsed. If, in contrast, only one message is received from the transmitting transceiver within this period of time, the switching node only forwards this one message.

In the second illustrative embodiment, too, each message is transmitted only once by each transceiver 2 in correspondence with a timing sequence control, apart from the above-mentioned exception. If the transmission of one of the two messages is interrupted in the second illustrative embodiment, each transceiver 2 can still continue to receive the message transmitted, in each case, in the opposite direction. The maximum jitter is defined by the length of one message in this communication arrangement.

FIG. 4 shows a third exemplary embodiment of the communication system. This illustrative embodiment essentially only differs from the structure shown in FIG. 3 in that the communication bus 1 is subdivided into two communication channels 1a and 1b. Communication channel 1a is provided exclusively for transmitting messages in the clockwise direction and communication channel 1b is exclusively provided transmitting messages in the counterclockwise direction. This communication system thus corresponds to a dual-ring structure. Correspondingly, receivers 11 and 15 and transmitters 12 and 16 are separately connected to the corresponding bus sections 9a, 9b, 10a and 10b of the respective communication channel 1a and 1b, respectively, according to FIG. 4.

In this illustrative embodiment, too, each transceiver 2 can transmit identical or different messages in different directions of transmission via the physically separate and independent communication channels 1a and 1b. Thus, for example, transceiver No. 3 can transmit a message in the clockwise direction to transceiver No. 1 via communication channel 1a and a further message in the counterclockwise direction to transceiver No. 2.

All transceivers 2 which are not transmitting activate their two receivers 11 and 15 for both directions of transmission and forward a received message by correspondingly activating the respective transmitters 16 and 12, respectively. If the transmission of one of the two messages transmitted in different directions is interrupted or disturbed, each transceiver 2 can still receive the message transmitted in the other direction of transmission.

The complexity of the communication system shown in FIG. 4 essentially corresponds to that of the communication systems shown in FIG. 2 and FIG. 3 in which only one bus ring is provided, since according to FIG. 4, too, only two receivers 11, 15 and two transmitters 12, 16 are required for each transceiver 2. The communication system shown in FIG. 4 only requires two additional transmitters if an acknowledgement of the reception of a transmitted signal is desired. The pin number of the transceivers is correspondingly increased.

I claim:

1. A communication system, comprising:
a plurality of transceivers;
a communication bus connected to said plurality of said transceivers to enable transmission of communication information between individual ones of said plurality of said transceivers;
said communication bus having a ring-shaped structure connecting each one of said plurality of said transceivers to a respective one of said plurality of said transceivers that is adjacent in a clockwise direction, defined as a respective clockwise adjacent transceiver, and to a respective one of said plurality of said transceivers that is adjacent in a counterclockwise direction, defined as a respective counterclockwise adjacent transceiver;
said communication bus having a plurality of bus sections defining a plurality of first bus sections and a plurality of second bus sections;
each one of said plurality of said transceivers being connected to said respective clockwise adjacent transceiver via a respective one of plurality of said first bus sections;
each one of said plurality of said transceivers being connected to said respective counterclockwise adjacent transceiver via a respective one of said plurality of said second bus sections;
each one of said plurality of said transceivers including a first receiver and a first transmitter that are associated with a respective one of said plurality of said first bus sections;
each one of said plurality of said transceivers including a second receiver and a second transmitter that are associated with a respective one of said plurality of said second bus sections;
each one of said plurality of said transceivers including a control device for controlling said first receiver of said one of said plurality of said transceivers, said second receiver of said one of said plurality of said transceivers, said first transmitter of said one of said plurality of said transceivers, and said second transmitter of said one of said plurality of said transceivers;
said control device being constructed to activate said first transmitter for transmitting first ones of the communication information in the clockwise direction via said communication bus; and
said control device being constructed to activate said second transmitter for transmitting second ones of the communication information in the counterclockwise direction via said communication bus.

2. The communication system according to claim wherein said control device of each one of said plurality of said transceivers is constructed such that, when the first ones of the communication information and the second ones of the communication information are not being transmitted by the one of said plurality of said transceivers, said control device activates said first receiver and said second receiver.

3. The communication system according to claim 2, wherein said control device of each one of said plurality of said transceivers is constructed such that, when ones of the communication information not intended for said one of said plurality of said transceivers is received by a receiver selected from the group consisting of said first receiver and said second receiver, said control device activates a transmitter selected from the group consisting of said first transmitter and said second transmitter.

4. The communication system according to claim 2, wherein:
said control device of each one of said plurality of said transceivers is constructed such that, when a communication information not intended for said one of said plurality of said transceivers is received by a receiver selected from the group consisting of said first receiver and said second receiver, then:
said control device activates a given transmitter, selected from the group consisting of said first transmitter and said second transmitter, only if no communication information is currently being received via one of said plurality of said bus sections associated with said given transmitter.

5. The communication system according to claim wherein each one of said plurality of said transceivers includes a storage device for storing communication information that is defined as stored communication information and that is selected from the group consisting of information to be transmitted and information to be forwarded.

6. The communication system according to claim 1, wherein:
said control device is constructed such that, if ones of the communication information are currently being received via said respective one of said plurality of said first bus sections and if said first transmitter is to be activated, then after a predetermined delay time, the stored communication information is read out from said storage device and is attempted to be forwarded via said respective one of said plurality of said first bus sections; and
said control device is constructed such that, if ones of the communication information are currently being received via said respective one of said plurality of said second bus sections and if said second transmitter is to be activated, then after a predetermined delay time, the stored communication information is read out from said storage device and is attempted to be forwarded via said respective one of said plurality of said second bus sections.

7. The communication system according to claim 1, wherein said control device is constructed such that, when an operation is being performed that is selected from the group consisting of transmitting the communication information and forwarding the communication information, said control device checks for an error and if the error is found, said control device, after a given delay time, causes an operation to be performed that is selected from the group consisting of retransmitting the communication information and forwarding the communication information via a transmitter that is selected from the group consisting of said first transmitter and said second transmitter.

8. The communication system according to claim 7, wherein:
said control device of each one of said plurality of said transceivers is constructed to identify retransmitted communication information; and
said control device of each one of said plurality of said transceivers is constructed such that:
when ones of the communication information, which are not intended for said one of said plurality of said transceivers and which have been identified as being retransmitted by said control device of another one of said plurality of said transceivers, are received during forwarding of the ones of the communication information because of an error, said control device of said one of said plurality of said transceivers prevents a retransmission of the ones of the communication information, and
when the ones of the communication information, which are not intended for said one of said plurality of said transceivers and which have been identified as being retransmitted by said control device of another one of said plurality of said transceivers, are received when a bus section, selected from the group consisting of an occupied one of said plurality of said first bus sections and an occupied one of said plurality of said second bus sections, via which the ones of the communication information are to be forwarded, said control device of said one of said plurality of said transceivers prevents a retransmission of the ones of the communication information.

9. The communication system according to claim wherein:
each one of said plurality of said transceivers includes a storage device for storing communication information that is defined as stored communication information and that is selected from the group consisting of information to be transmitted and information to be forwarded;
for each one of the communication information to be transmitted, a particular one of said plurality of said transceivers is defined as switching unit;
said control device of said switching unit is constructed such that, when corresponding ones of the communication information are received via a corresponding bus section selected from the group consisting of one of said plurality of said first bus sections and one of said plurality of said second bus sections, said control device of said switching unit temporarily stores the ones of the communication information in said storage means of said switching unit and forwards the ones of the communication information via another corresponding bus section selected from the group consisting of one of said plurality of said first bus sections and one of said plurality of said second bus sections, after a predetermined period of time has elapsed.

10. The communication system according to claim 9, wherein:
said control device of said switching unit is constructed such that, if within the predetermined period of time, the corresponding ones of the communication information have been received both via one of said plurality of said first bus sections and one of said plurality of said second bus sections, said control device of said switching unit temporarily stores the corresponding ones of the communication information and after the predetermined period of time has elapsed, said control device of said switching unit forwards the corresponding ones of the communication information.

11. The communication system according to claim 9, wherein:
said control device of said switching unit is constructed such that, if within the predetermined period of time, the corresponding ones of the communication information have been received only via a bus section selected from the group consisting of one of said plurality of said first bus sections and one of said plurality of said second bus sections, said control device of said switching unit only reads out of said storage means and forwards the corresponding ones of the communication information.

12. The communication system according to claim 1, wherein:
said communication bus includes a first communication channel for exclusively transmitting the communication information in the clockwise direction; and
said communication bus includes a second communication channel for exclusively transmitting the communication information in the counterclockwise direction.

13. The communication system according to claim 12, wherein:
said first receiver of each one of said plurality of said transceivers has an input connected to said second communication channel of said plurality of said first bus sections;
said second receiver of each one of said plurality of said transceivers has an input connected to said first communication channel of said plurality of said second bus sections;
said first transmitter of each one of said plurality of said transceivers has an output connected to said first communication channel of said plurality of said first bus sections; and
said second transmitter of each one of said plurality of said transceivers has an output connected to said second communication channel of said plurality of said second bus sections.

14. The communication system according to claim 12, wherein:
said control device is constructed to activate said first transmitter to transmit the first ones of the communication information in the clockwise direction via said first communication channel; and
said control device is constructed to activate said second transmitter to transmit the second ones of the communication information in the counterclockwise direction via said second communication channel.

15. A communication system, comprising:
a plurality of transceivers;
a communication bus connected to said plurality of said transceivers to enable transmission of communication information between individual ones of said plurality of said transceivers;
said communication bus having a ring-shaped structure connecting each one of said plurality of said transceivers to a respective one of said plurality of said transceivers that is adjacent in a clockwise direction, defined as a respective clockwise adjacent transceiver, and to a respective one of said plurality of said transceivers that is adjacent in a counterclockwise direction, defined as a respective counterclockwise adjacent transceiver;
said communication bus having a plurality of bus sections defining a plurality of first bus sections and a plurality of second bus sections;
each one of said plurality of said transceivers being connected to said respective clockwise adjacent transceiver via a respective one of plurality of said first bus sections;
each one of said plurality of said transceivers being connected to said respective counterclockwise adjacent transceiver via a respective one of said plurality of said second bus sections;
each one of said plurality of said transceivers including a first receiver and a first transmitter that are associated with a respective one of said plurality of said first bus sections;
each one of said plurality of said transceivers including a second receiver and a second transmitter that are associated with a respective one of said plurality of said second bus sections;
each one of said plurality of said transceivers including a control device for controlling said first receiver of said one of said plurality of said transceivers, said second receiver of said one of said plurality of said transceivers, said first transmitter of said one of said plurality of said transceivers, and said second transmitter of said one of said plurality of said transceivers; and
each one of said plurality of said transceivers including a storage device for storing stored communication information selected from the group consisting of information to be transmitted to another one of said plurality of said transceivers and information to be forwarded to another one of said plurality of said transceivers.

16. The communication system according to claim 15, wherein said control device of each one of said plurality of said transceivers is constructed such that, when the communication information is not being transmitted by the one of said plurality of said transceivers, said control device activates said first receiver and said second receiver.

17. The communication system according to claim 15, wherein said control device of each one of said plurality of said transceivers is constructed such that, when ones of the communication information not intended for said one of said plurality of said transceivers is received by a receiver selected from the group consisting of said first receiver and said second receiver, said control device forwards the ones of the communication information by activating a transmitter selected from the group consisting of said first transmitter and said second transmitter.

18. The communication system according to claim 15, wherein:
said control device is constructed to activate said first transmitter to transmit given ones of the communication information in the clockwise direction via said communication bus; and
said control device is constructed to activate said second transmitter to transmit the given ones of the communication information in the counterclockwise direction via said communication bus.

19. The communication system according to claim 15, wherein:
said control device is constructed to activate said first transmitter to transmit first ones of the communication information in the clockwise direction via said communication bus; and
said control device is constructed to activate said second transmitter to transmit second ones of the communication information in the counterclockwise direction via said communication bus.

20. The communication system according to claim 15, wherein:
said control device of each one of said plurality of said transceivers is constructed such that, when a communication information not intended for said one of said plurality of said transceivers is received by a receiver selected from the group consisting of said first receiver and said second receiver, then:
said control device activates a given transmitter, selected from the group consisting of said first transmitter and said second transmitter, only if no communication information is currently being received via one of said plurality of said bus sections associated with said given transmitter.

21. The communication system according to claim 15, wherein:
said control device is constructed such that, if ones of the communication information are currently being received via said respective one of said plurality of said first bus sections and if said first transmitter is to be activated, then after a predetermined delay time, the stored communication information is read out from said storage device and is attempted to be forwarded via said respective one of said plurality of said first bus sections; and
said control device is constructed such that, if ones of the communication information are currently being received via said respective one of said plurality of said second bus sections and if said second transmitter is to be activated, then after a predetermined delay time, the stored communication information is read out from said storage device and is attempted to be forwarded via said respective one of said plurality of said second bus sections.

22. The communication system according to claim 15, wherein said control device is constructed such that, when an operation is being performed that is selected from the group consisting of transmitting the communication information and forwarding the communication information, said control device checks for an error and if the error is found, said control device, after a given delay time, causes an operation to be performed that is selected from the group consisting of retransmitting the stored communication information and forwarding the stored communication information via a transmitter that is selected from the group consisting of said first transmitter and said second transmitter.

23. The communication system according to claim 22, wherein:
said control device of each one of said plurality of said transceivers is constructed to identify retransmitted communication information; and
said control device of each one of said plurality of said transceivers is constructed such that:
when ones of the communication information, which are not intended for said one of said plurality of said transceivers and which have been identified as being retransmitted by said control device of another one of said plurality of said transceivers, are received during forwarding of the ones of the communication information because of an error, said control device of said one of said plurality of said transceivers prevents a retransmission of the ones of the communication information, and
when the ones of the communication information, which are not intended for said one of said plurality of said transceivers and which have been identified as being retransmitted by said control device of another one of said plurality of said transceivers, are received when a bus section, selected from the group consisting of an occupied one of said plurality of said first bus sections and an occupied one of said plurality of said second bus sections, via which the ones of the communication information are to be forwarded, said control device of said one of said plurality of said transceivers prevents a retransmission of the ones of the communication information.

24. The communication system according to claim 15, wherein:
each one of said plurality of said transceivers includes a storage device for storing communication information that is defined as stored communication information and that is selected from the group consisting of information to be transmitted and information to be forwarded;
for each one of the communication information to be transmitted, a particular one of said plurality of said transceivers is defined as switching unit;
said control device of said switching unit is constructed such that, when corresponding ones of the communication information are received via a corresponding bus section selected from the group consisting of one of said plurality of said first bus sections and one of said plurality of said second bus sections, said control device of said switching unit temporarily stores the ones of the communication information in said storage means of said switching unit and forwards the ones of the communication information via another corresponding bus section selected from the group consisting of one of said plurality of said first bus sections and one of said plurality of said second bus sections, after a predetermined period of time has elapsed.

25. The communication system according to claim 24, wherein:
said control device of said switching unit is constructed such that, if within the predetermined period of time, the corresponding ones of the communication information have been received both via one of said plurality of said first bus sections and one of said plurality of said second bus sections, said control device of said switching unit temporarily stores the corresponding ones of the communication information and after the predetermined period of time has elapsed, said control device of said switching unit forwards the corresponding ones of the communication information.

26. The communication system according to claim 24, wherein:
said control device of said switching unit is constructed such that, if within the predetermined period of time, the corresponding ones of the communication information have been received only via a bus section selected from the group consisting of one of said plurality of said first bus sections and one of said plurality of said second bus sections, said control device of said switching unit only reads out of said storage means and forwards the corresponding ones of the communication information.

27. The communication system according to claim 15, wherein:
said communication bus includes a first communication channel for exclusively transmitting the communication information in the clockwise direction; and
said communication bus includes a second communication channel for exclusively transmitting the communication information in the counterclockwise direction.

28. The communication system according to claim 27, wherein:
said first receiver of each one of said plurality of said transceivers has an input connected to said second communication channel of said plurality of said first bus sections;
said second receiver of each one of said plurality of said transceivers has an input connected to said first communication channel of said plurality of said second bus sections;
said first transmitter of each one of said plurality of said transceivers has an output connected to said first communication channel of said plurality of said first bus sections; and
said second transmitter of each one of said plurality of said transceivers has an output connected to said second communication channel of said plurality of said second bus sections.

29. The communication system according to claim 27, wherein:
said control device is constructed to activate said first transmitter to transmit given ones of the communication information in the clockwise direction via said first communication channel; and
said control device is constructed to activate said second transmitter to transmit the given ones of the communication information in the counterclockwise direction via said second communication channel.

30. The communication system according to claim 27, wherein:
said control device is constructed to activate said first transmitter to transmit first ones of the communication information in the clockwise direction via said first communication channel; and
said control device is constructed to activate said second transmitter to transmit second ones of the communication information in the counterclockwise direction via said second communication channel.

31. A communication system, comprising:
a plurality of transceivers;
a communication bus connected to said plurality of said transceivers to enable transmission of communication information between individual ones of said plurality of said transceivers;
said communication bus having a ring-shaped structure connecting each one of said plurality of said transceivers to a respective one of said plurality of said transceivers that is adjacent in a clockwise direction, defined as a respective clockwise adjacent transceiver, and to a respective one of
said plurality of said transceivers that is adjacent in a counterclockwise direction, defined as a respective counterclockwise adjacent transceiver;
said communication bus having a plurality of bus sections defining a plurality of first bus sections and a plurality of second bus sections;
each one of said plurality of said transceivers being connected to said respective clockwise adjacent transceiver via a respective one of plurality of said first bus sections;
each one of said plurality of said transceivers being connected to said respective counterclockwise adjacent transceiver via a respective one of said plurality of said second bus sections;
each one of said plurality of said transceivers including a first receiver and a first transmitter that are associated with a respective one of said plurality of said first bus sections;
each one of said plurality of said transceivers including a second receiver and a second transmitter that are associated with a respective one of said plurality of said second bus sections;
each one of said plurality of said transceivers including a control device for controlling said first receiver of said one of said plurality of said transceivers, said second receiver of said one of said plurality of said transceivers, said first transmitter of said one of said plurality of said transceivers, and said second transmitter of said one of said plurality of said transceivers;
said control device being constructed such that, when an operation is being performed that is selected from the group consisting of transmitting the communication information and forwarding the communication information, said control device checks for an error and if the error is found, said control device, after a given delay time, causes an operation to be performed that is selected from the group consisting of retransmitting the communication information and forwarding the communication information via a transmitter that is selected from the group consisting of said first transmitter and said second transmitter.

32. The communication system according to claim 31, wherein said control device of each one of said plurality of said transceivers is constructed such that, when the communication information is not being transmitted by the one of said plurality of said transceivers, said control device activates said first receiver and said second receiver.

33. The communication system according to claim 31, wherein said control device of each one of said plurality of said transceivers is constructed such that, when ones of the communication information not intended for said one of said plurality of said transceivers is received by a receiver selected from the group consisting of said first receiver and said second receiver, said control device forwards the ones of the communication information by activating a transmitter selected from the group consisting of said first transmitter and said second transmitter.

34. The communication system according to claim 31, wherein:
said control device is constructed to activate said first transmitter to transmit given ones of the communication information in the clockwise direction via said communication bus; and
said control device is constructed to activate said second transmitter to transmit the given ones of the communication information in the counterclockwise direction via said communication bus.

35. The communication system according to claim 31, wherein:
said control device is constructed to activate said first transmitter to transmit first ones of the communication information in the clockwise direction via said communication bus; and
said control device is constructed to activate said second transmitter to transmit second ones of the communication information in the counterclockwise direction via said communication bus.

36. The communication system according to claim 31, wherein:
said control device of each one of said plurality of said transceivers is constructed such that, when a communication information not intended for said one of said plurality of said transceivers is received by a receiver selected from the group consisting of said first receiver and said second receiver, then:
said control device activates a given transmitter, selected from the group consisting of said first transmitter and said second transmitter, only if no communication information is currently being received via one of said plurality of said bus sections associated with said given transmitter.

37. The communication system according to claim 31, wherein each one of said plurality of said transceivers includes a storage device for storing communication information that is defined as stored communication information and that is selected from the group consisting of information to be transmitted and information to be forwarded.

38. The communication system according to claim 37, wherein:
said control device is constructed such that, if ones of the communication information are currently being received via said respective one of said plurality of said first bus sections and if said first transmitter is to be activated, then after a predetermined delay time, the stored communication information is read out from said storage device and is attempted to be forwarded via said respective one of said plurality of said first bus sections; and
said control device is constructed such that, if ones of the communication information are currently being received via said respective one of said plurality of said second bus sections and if said second transmitter is to be activated, then after a predetermined delay time, the stored communication information is read out from said storage device and is attempted to be forwarded via said respective one of said plurality of said second bus sections.

39. The communication system according to claim 31, wherein:
said control device of each one of said plurality of said transceivers is constructed to identify retransmitted communication information; and
said control device of each one of said plurality of said transceivers is constructed such that:
when ones of the communication information, which are not intended for said one of said plurality of said transceivers and which have been identified as being retransmitted by said control device of another one of said plurality of said transceivers, are received during forwarding of the ones of the communication information because of an error, said control device of said one of said plurality of said transceivers prevents a retransmission of the ones of the communication information, and
when the ones of the communication information, which are not intended for said one of said plurality of said transceivers and which have been identified as being retransmitted by said control device of another one of said plurality of said transceivers, are received when a bus section, selected from the group consisting of an occupied one of said plurality of said first bus sections and an occupied one of said plurality of said second bus sections, via which the ones of the communication information are to be forwarded, said control device of said one of said plurality of said transceivers prevents a retransmission of the ones of the communication information.

40. The communication system according to claim 31, wherein:
each one of said plurality of said transceivers includes a storage device for storing communication information that is defined as stored communication information and that is selected from the group consisting of information to be transmitted and information to be forwarded;
for each one of the communication information to be transmitted, a particular one of said plurality of said transceivers is defined as switching unit;
said control device of said switching unit is constructed such that, when corresponding ones of the communication information are received via a corresponding bus section selected from the group consisting of one of said plurality of said first bus sections and one of said plurality of said second bus sections, said control device of said switching unit temporarily stores the ones of the communication information in said storage means of said switching unit and forwards the ones of the communication information via another corresponding bus section selected from the group consisting of one of said plurality of said first bus sections and one of said plurality of said second bus sections, after a predetermined period of time has elapsed.

41. The communication system according to claim 40, wherein:
said control device of said switching unit is constructed such that, if within the predetermined period of time, the corresponding ones of the communication information have been received both via one of said plurality of said first bus sections and one of said plurality of said second bus sections, said control device of said switching unit temporarily stores the corresponding ones of the communication information and after the predetermined period of time has elapsed, said control device of said switching unit forwards the corresponding ones of the communication information.

42. The communication system according to claim 40, wherein:
said control device of said switching unit is constructed such that, if within the predetermined period of time, the corresponding ones of the communication information have been received only via a bus section selected from the group consisting of one of said plurality of said first bus sections and one of said plurality of said second bus sections, said control device of said switching unit only reads out of said storage means and forwards the corresponding ones of the communication information.

43. The communication system according to claim 31, wherein:
said communication bus includes a first communication channel for exclusively transmitting the communication information in the clockwise direction; and
said communication bus includes a second communication channel for exclusively transmitting the communication information in the counterclockwise direction.

44. The communication system according to claim 43, wherein:
said first receiver of each one of said plurality of said transceivers has an input connected to said second communication channel of said plurality of said first bus sections;
said second receiver of each one of said plurality of said transceivers has an input connected to said first communication channel of said plurality of said second bus sections;
said first transmitter of each one of said plurality of said transceivers has an output connected to said first communication channel of said plurality of said first bus sections; and
said second transmitter of each one of said plurality of said transceivers has an output connected to said second communication channel of said plurality of said second bus sections.

45. The communication system according to claim 43, wherein:
said control device is constructed to activate said first transmitter to transmit given ones of the communication information in the clockwise direction via said first communication channel; and
said control device is constructed to activate said second transmitter to transmit the given ones of the communication information in the counterclockwise direction via said second communication channel.

46. The communication system according to claim 43, wherein:
said control device is constructed to activate said first transmitter to transmit first ones of the communication information in the clockwise direction via said first communication channel; and
said control device is constructed to activate said second transmitter to transmit second ones of the communication information in the counterclockwise direction via said second communication channel.

47. A communication system, comprising:
a plurality of transceivers;
a communication bus connected to said plurality of said transceivers to enable transmission of communication information between individual ones of said plurality of said transceivers;
said communication bus having a ring-shaped structure connecting each one of said plurality of said transceivers to a respective one of said plurality of said transceivers that is adjacent in a clockwise direction, defined as a respective clockwise adjacent transceiver, and to a respective one of said plurality of said transceivers that is adjacent in a counterclockwise direction, defined as a respective counterclockwise adjacent transceiver;
said communication bus having a plurality of bus sections defining a plurality of first bus sections and a plurality of second bus sections;
each one of said plurality of said transceivers being connected to said respective clockwise adjacent transceiver via a respective one of plurality of said first bus sections;
each one of said plurality of said transceivers being connected to said respective counterclockwise adjacent transceiver via a respective one of said plurality of said second bus sections;
each one of said plurality of said transceivers including a first receiver and a first transmitter that are associated with a respective one of said plurality of said first bus sections;
each one of said plurality of said transceivers including a second receiver and a second transmitter that are associated with a respective one of said plurality of said second bus sections;
each one of said plurality of said transceivers including a control device for controlling said first receiver of said one of said plurality of said transceivers, said second receiver of said one of said plurality of said transceivers, said first transmitter of said one of said plurality of said transceivers, and said second transmitter of said one of said plurality of said transceivers; and
said control device being constructed to identify faulty communication information and to forward the identified faulty communication information.

48. The communication system according to claim 47, wherein said control device of each one of said plurality of said transceivers is constructed such that, when the communication information is not being transmitted by the one of said plurality of said transceivers, said control device activates said first receiver and said second receiver.

49. The communication system according to claim 47, wherein said control device of each one of said plurality of said transceivers is constructed such that, when ones of the communication information not intended for said one of said plurality of said transceivers is received by a receiver selected from the group consisting of said first receiver and said second receiver, said control device forwards the ones of the communication information by activating a transmitter selected from the group consisting of said first transmitter and said second transmitter.

50. The communication system according to claim 47, wherein:
said control device is constructed to activate said first transmitter to transmit given ones of the communication information in the clockwise direction via said communication bus; and
said control device is constructed to activate said second transmitter to transmit the given ones of the communication information in the counterclockwise direction via said communication bus.

51. The communication system according to claim 47, wherein:
said control device is constructed to activate said first transmitter to transmit first ones of the communication information in the clockwise direction via said communication bus; and
said control device is constructed to activate said second transmitter to transmit second ones of the communication information in the counterclockwise direction via said communication bus.

52. The communication system according to claim 51, wherein:
said control device of each one of said plurality of said transceivers is constructed such that, when a communication information not intended for said one of said plurality of said transceivers is received by a receiver selected from the group consisting of said first receiver and said second receiver, then:
said control device activates a given transmitter, selected from the group consisting of said first transmitter and said second transmitter, only if no communication information is currently being received via one of said plurality of said bus sections associated with said given transmitter.

53. The communication system according to claim 47, wherein each one of said plurality of said transceivers includes a storage device for storing communication information that is defined as stored communication information and that is selected from the group consisting of information to be transmitted and information to be forwarded.

54. The communication system according to claim 53, wherein:
said control device is constructed such that, if ones of the communication information are currently being received via said respective one of said plurality of said first bus sections and if said first transmitter is to be activated, then after a predetermined delay time, the stored communication information is read out from said storage device and is attempted to be forwarded via said respective one of said plurality of said first bus sections; and
said control device is constructed such that, if ones of the communication information are currently being received via said respective one of said plurality of said second bus sections and if said second transmitter is to be activated, then after a predetermined delay time, the stored communication information is read out from said storage device and is attempted to be forwarded via said respective one of said plurality of said second bus sections.

55. The communication system according to claim 53, wherein said control device is constructed such that, when an operation is being performed that is selected from the group consisting of transmitting the communication information and forwarding the communication information, said control device checks the communication information for an error and if the error is found, said control device, after a given delay time, causes an operation to be performed that is selected from the group consisting of retransmitting the stored communication information and forwarding the stored communication information via a transmitter that is selected from the group consisting of said first transmitter and said second transmitter.

56. The communication system according to claim 47, wherein:
said control device of each one of said plurality of said transceivers is constructed to identify retransmitted communication information; and
said control device of each one of said plurality of said transceivers is constructed such that:
when ones of the communication information, which are not intend ed for said one of said plurality of said transceivers and which have been identified as being retransmitted by said control device of another one of said plurality of said transceivers, are received during forwarding of the ones of the communication information because of an error, said control device of said one of said plurality of said transceivers prevents a retransmission of the ones of the communication information, and
when the ones of the communication information, which are not intended for said one of said plurality of said transceivers and which have been identified as being retransmitted by said control device of another one of said plurality of said transceivers, are received when a bus section, selected from the group consisting of an occupied one of said plurality of said first bus sections and an occupied one of said plurality of said second bus sections, via which the ones of the communication information are to be forwarded, said control device of said one of said plurality of said transceivers prevents a retransmission of the ones of the communication information.

57. The communication system according to claim 47, wherein:
each one of said plurality of said transceivers includes a storage device for storing communication information that is defined as stored communication information and that is selected from the group consisting of information to be transmitted and information to be forwarded;
for each one of the communication information to be transmitted, a particular one of said plurality of said transceivers is defined as switching unit;
said control device of said switching unit is constructed such that, when corresponding ones of the communication information are received via a corresponding bus section selected from the group consisting of one of said plurality of said first bus sections and one of said plurality of said second bus sections, said control device of said switching unit temporarily stores the ones of the communication information in said storage means of said switching unit and forwards the ones of the communication information via another corresponding bus section selected from the group consisting of one of said plurality of said first bus sections and one of said plurality of said second bus sections, after a predetermined period of time has elapsed.

58. The communication system according to claim 57, wherein:
said control device of said switching unit is constructed such that, if within the predetermined period of time, the corresponding ones of the communication information have been received both via one of said plurality of said first bus sections and one of said plurality of said second bus sections, said control device of said switching unit temporarily stores the corresponding ones of the communication information and after the predetermined period of time has elapsed, said control device of said switching unit forwards the corresponding ones of the communication information.

59. The communication system according to claim 57, wherein:
said control device of said switching unit is constructed such that, if within the predetermined period of time, the corresponding ones of the communication information have been received only via a bus section selected from the group consisting of one of said plurality of said first bus sections and one of said plurality of said second bus sections, said control device of said switching unit only reads out of said storage means and forwards the corresponding ones of the communication information.

60. The communication system according to claim 47, wherein:
said communication bus includes a first communication channel for exclusively transmitting the communication information in the clockwise direction; and
said communication bus includes a second communication channel for exclusively transmitting the communication information in the counterclockwise direction.

61. The communication system according to claim 60, wherein:
said first receiver of each one of said plurality of said
transceivers has an input connected to said second communication channel of said plurality of said first bus sections;
said second receiver of each one of said plurality of said transceivers has an input connected to said first communication channel of said plurality of said second bus sections;
said first transmitter of each one of said plurality of said transceivers has an output connected to said first communication channel of said plurality of said first bus sections; and
said second transmitter of each one of said plurality of said transceivers has an output connected to said second communication channel of said plurality of said second bus sections.

62. The communication system according to claim 60, wherein:
said control device is constructed to activate said first transmitter to transmit given ones of the communication information in the clockwise direction via said first communication channel; and
said control device is constructed to activate said second transmitter to transmit the given ones of the communication information in the counterclockwise direction via said second communication channel.

63. The communication system according to claim 60, wherein:
said control device is constructed to activate said first transmitter to transmit first ones of the communication information in the clockwise direction via said first communication channel; and
said control device is constructed to activate said second transmitter to transmit second ones of the communication information in the counterclockwise direction via said second communication channel.
